(19) United States
(12) Patent Application Publication
(10) Pub. No.: US 2007/0277566 A1
(43) Pub. Date: Dec. 6, 2007

(54) Lock for electronic apparatus

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/483,621

(22) Filed: Jul. 11, 2006

(30) Foreign Application Priority Data
Jun. 6, 2006 (TW) 095120085

(51) Int. Cl. E05B 73/00

(52) U.S. Cl. 70/58

(57) ABSTRACT

A lock for an electronic apparatus includes a housing, a snapping member, a control member, a locking mechanism, and a cable. Thus, the electronic apparatus is locked by the lock so as to attach the electronic apparatus to a fixing body by the lock so that the electronic apparatus is limited to move in a determined field so as to achieve an anti-theft purpose. In addition, the plug of the snapping member is directly inserted into the slot of the electronic apparatus to lock the electronic apparatus, so that the lock is operated easily and conveniently, thereby facilitating the user locking the electronic apparatus by the lock.

### BACKGROUND OF THE INVENTION

1. Field of the Invention

The present invention relates to a lock, and more particularly to a lock for an electronic apparatus having a smaller size, such as a PDA, iPAQ, MP3 or cell phone.

2. Description of the Related Art

An electronic apparatus, such as a PDA, iPAQ, MP3 or cell phone is often placed on an exhibition table to attract attention of the consumers. However, the electronic apparatus has a smaller size, so that it is easily missed or lost.

A conventional cable lock disclosed in the Taiwanese Patent Publication Nos. 489885, 501643 and 517768 is used to lock a notebook computer so that the notebook computer is limited by the lock to move in a determined field to achieve an anti-theft purpose. A Further conventional cable lock also disclosed in the U.S. Pat. Nos. 6,401,502 and 6,622,532. However, the conventional cable lock is not available for an electronic apparatus having a smaller size.

### SUMMARY OF THE INVENTION

The primary objective of the present invention is to provide a lock for locking and attaching an electronic apparatus onto a fixing body.

Another objective of the present invention is to provide a lock for an electronic apparatus, wherein the electronic apparatus is locked by the lock so as to attach the electronic apparatus to the fixing body by the lock so that the electronic apparatus is limited to move in a determined field so as to achieve an anti-theft purpose.

A further objective of the present invention is to provide a lock for an electronic apparatus, wherein the plug of the snapping member is directly inserted into the slot of the electronic apparatus to lock the electronic apparatus, so that the lock is operated easily and conveniently, thereby facilitating the user locking the electronic apparatus by the lock.

In accordance with the present invention, there is provided a lock, comprising:

a housing;

a snapping member mounted on the housing and including a plug protruding from the housing and inserted into a slot of an electronic apparatus, and two snapping hooks movably mounted on two opposite sides of the plug and detachably hooked onto two opposite sides of the slot of the electronic apparatus;

a control member movably mounted on the housing and movable to an open position where the two snapping hooks are detached from the slot of the electronic apparatus;

a locking mechanism mounted on the housing to limit movement of the control member to the open position.

Further benefits and advantages of the present invention will become apparent after a careful reading of the detailed description with appropriate reference to the accompanying drawings.

### BRIEF DESCRIPTION OF THE DRAWINGS

FIG. 1 is a partially exploded perspective view of a lock for an electronic apparatus in accordance with the preferred embodiment of the present invention;

FIG. 2 is a plan cross-sectional assembly view of the lock for the electronic apparatus as shown in FIG. 1;

FIG. 3 is a schematic operational view of the lock for the electronic apparatus as shown in FIG. 2;

FIG. 4 is a perspective view showing usage of the lock for the electronic apparatus as shown in FIG. 1;

FIG. 5 is a perspective view of a lock for an electronic apparatus in accordance with another preferred embodiment of the present invention; and

FIG. 6 is a perspective view showing usage of the lock for the electronic apparatus as shown in FIG. 5.

### DETAILED DESCRIPTION OF THE INVENTION

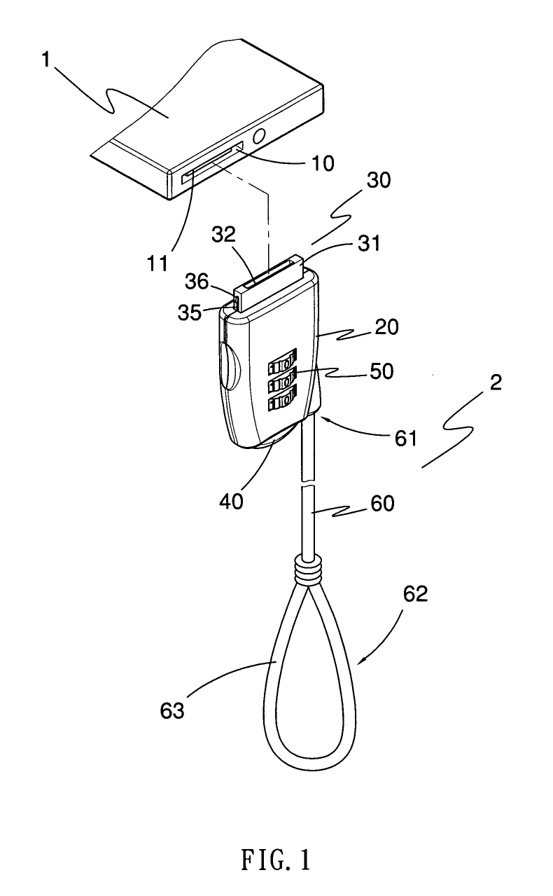

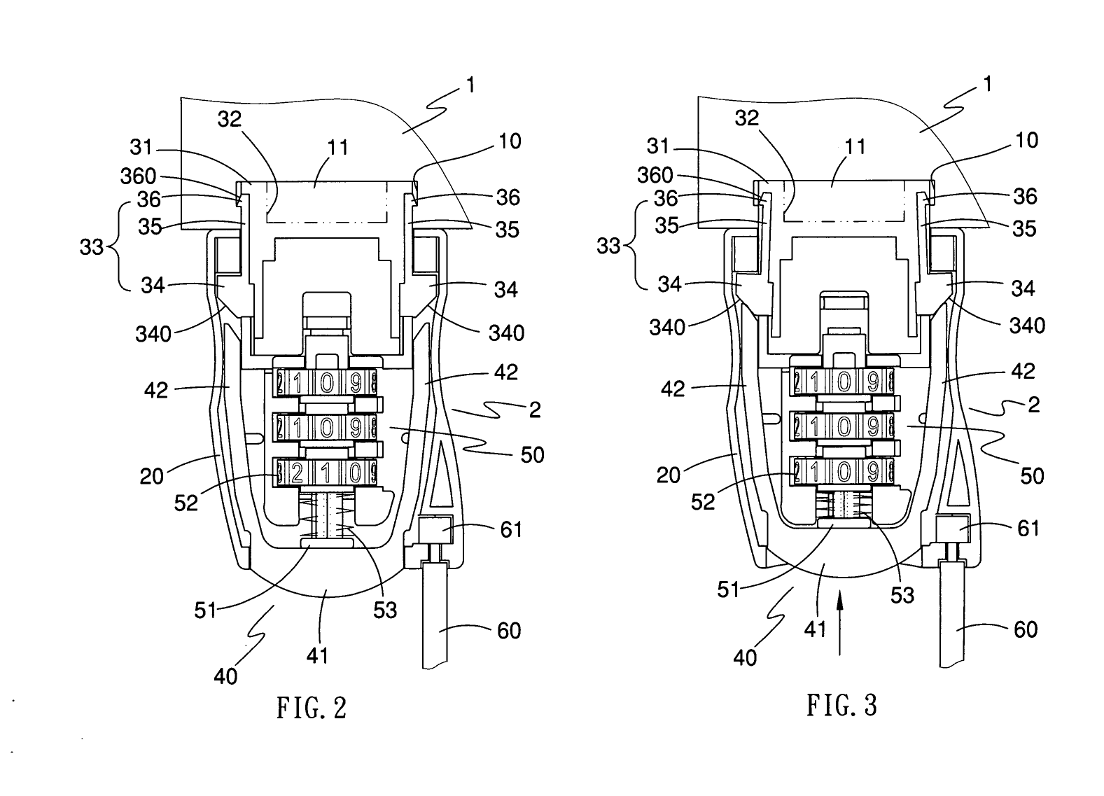

Referring to the drawings and initially to FIGS. 1 and 2, a lock 2 for an electronic apparatus 1 in accordance with the preferred embodiment of the present invention comprises a housing 20, a snapping member 30, a control member 40, a locking mechanism 50, and a cable 60.

The electronic apparatus 1 has a slot 10 to receive a transmission connector 11. Preferably, the electronic apparatus 1 is a PDA, iPAQ, MP3 or cell phone, and the slot 10 is an information transmission slot or electric transmission slot.

The snapping member 30 is mounted on the housing 20 and includes a plug 31 protruding from the housing 20 and inserted into the slot 10 of the electronic apparatus 1, and two snapping hooks 33 movably mounted on two opposite sides of the plug 31 and detachably hooked onto two opposite sides of the slot 10 of the electronic apparatus 1. The plug 31 of the snapping member 30 has an end face formed with a receiving hole 32 to receive the transmission connector 11 of the electronic apparatus 1.

The control member 40 is movably mounted on the housing 20 and movable to an open position where the two snapping hooks 33 are detached from the slot 10 of the electronic apparatus 1.

The locking mechanism 50 is mounted on the housing 20 to limit movement of the control member 40 to the open position.

The cable 60 has a first end provided with an attachment 61 attached to the housing 20 and a second end 62 provided with a loop 63 to allow passage of the housing 20. The electronic apparatus 1 cannot pass through the loop 63 of the cable 60.

Each of the two snapping hooks 33 includes a driven block 34 elastically and swingably mounted on one of the two opposite sides of the plug 31 and having a side formed with an oblique driven face 340, a link 35 protruding from the plug 31 and having a first end extending from the driven block 34, and a hook portion 36 protruding from a second end of the link 35 and detachably hooked onto one of the two opposite sides of the slot 10 of the electronic apparatus 1. The hook portion 36 of each of the two snapping hooks 33 has a side formed with an oblique guide face 360.

The control member 40 includes a press portion 41 having an outer side protruding from the housing 20, and two push bars 42 extending from the press portion 41 toward the driven blocks 34 of the two snapping hooks 33.

The locking mechanism 50 includes a number wheel unit 52 mounted on the housing 20, a control shaft 51 extending through the number wheel unit 52 and having an end portion rested on an inner side of the press portion 41 of the control member 40, and a compression spring 53 mounted on the control shaft 51 and biased between the number wheel unit 52 and the end portion of the control shaft 51 to push the control shaft 51 toward the press portion 41 of the control member 40. Thus, when the number wheel unit 52 of the locking mechanism 50 is disposed at an unlocked state (the code of the number wheel unit 52 is correct), the control shaft 51 is movable, and when the number wheel unit 52 of the locking mechanism 50 is disposed at a locked state (the code of the number wheel unit 52 is incorrect), the control shaft 51 is fixed.

As shown in FIG. 3, when the number wheel unit 52 of the locking mechanism 50 is disposed at the unlocked state (the code of the number wheel unit 52 is correct), the control shaft 51 is movable, so that the press portion 41 of the control member 40 is released from the control shaft 51. Thus, when the press portion 41 of the control member 40 is pressed toward the housing 20, the compression spring 53 of the locking mechanism 50 is compressed to store a restoring force, and each of the push bars 42 of the control member 40 is pushed toward the driven block 34 of the respective snapping hook 33 to press the driven face 340 of the driven block 34 to retract the driven block 34, the link 35 and the hook portion 36 inwardly toward the plug 31 so as to detach the hook portion 36 from the slot 10 of the electronic apparatus 1, so that the plug 31 of the snapping member 30 can be inserted into and detached from the slot 10 of the electronic apparatus 1.

As shown in FIG. 2, after the plug 31 of the snapping member 30 is inserted into the slot 10 of the electronic apparatus 1, the control shaft 51 is pushed outwardly by the restoring force of the compression spring 53 of the locking mechanism 50 to push the press portion 41 of the control member 40 outwardly to detach each of the push bars 42 of the control member 40 from the driven block 34 of the respective snapping hook 33, so that the driven block 34, the link 35 and the hook portion 36 are moved outwardly from the plug 31 by the elastic action of the driven block 34, and the hook portion 36 is hooked onto one of the two opposite sides of the slot 10 of the electronic apparatus 1 again, thereby locking the electronic apparatus 1. Thus, when the number wheel unit 52 of the locking mechanism 50 is disposed at the locked state (the code of the number wheel unit 52 is incorrect), the control shaft 51 is fixed, so that the press portion 41 of the control member 40 is locked by the control shaft 51.

Alternatively, when the number wheel unit 52 of the locking mechanism 50 is disposed at the locked state (the code of the number wheel unit 52 is incorrect), the plug 31 of the snapping member 30 is directly inserted into the slot 10 of the electronic apparatus 1. At this time, the oblique guide face 360 of the hook portion 36 of each of the two snapping hooks 33 is pressed by one of the two opposite sides of the slot 10 of the electronic apparatus 1 to retract the driven block 34, the link 35 and the hook portion 36 inwardly toward the plug 31, so that the plug 31 of the snapping member 30 is inserted into the slot 10 of the electronic apparatus 1. After the hook portion 36 of each of the two snapping hooks 33 is inserted into the slot 10 of the electronic apparatus 1, the link 35 and the hook portion 36 are moved outwardly from the plug 31 by the elastic action of the driven block 34, and the hook portion 36 is hooked onto one of the two opposite sides of the slot 10 of the electronic apparatus 1 again, thereby locking the electronic apparatus 1.

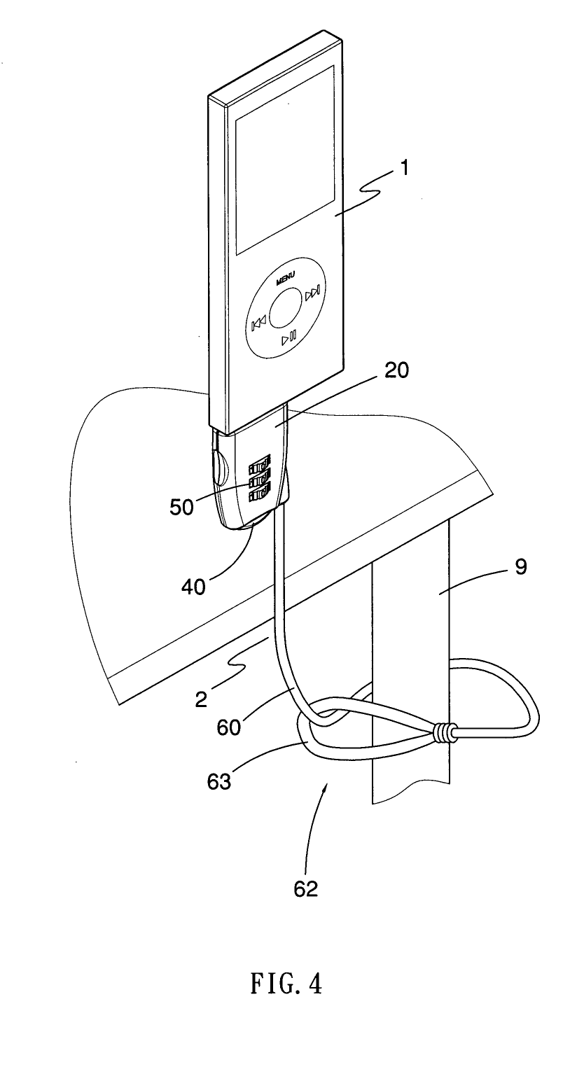

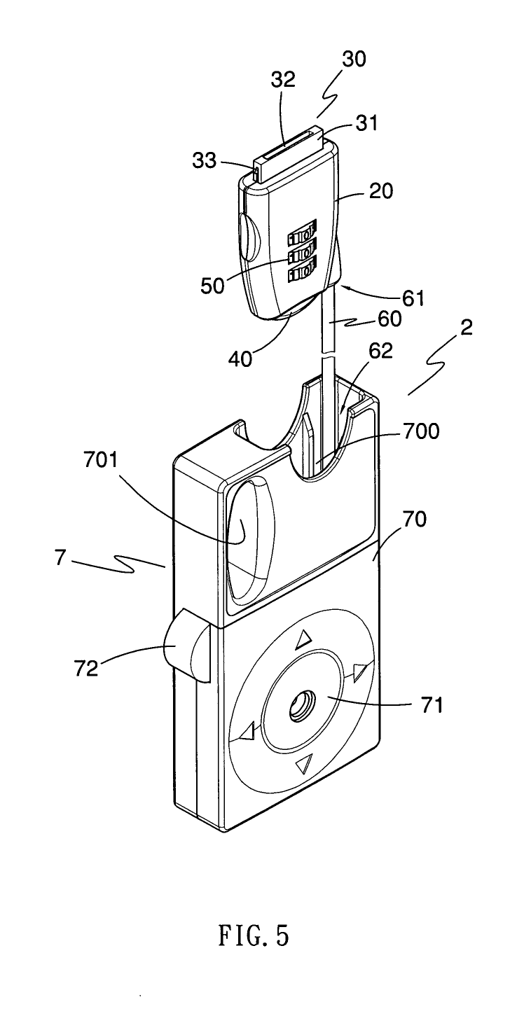

As shown in FIGS. 1 and 4, when the lock is mounted on a fixing body 9, such as a fixed leg of a table, the cable 60 is reeved through the fixing body 9, and the housing 20 is passed through the loop 63 of the cable 60 so that the cable 60 is fixed on the fixing body 9. Then, the plug 31 of the snapping member 30 is directly inserted into the slot 10 of the electronic apparatus 1 to lock the electronic apparatus 1 so as to attach the electronic apparatus 1 to the fixing body 9 so that the electronic apparatus 1 is limited to move in a determined field so as to achieve an anti-theft purpose.

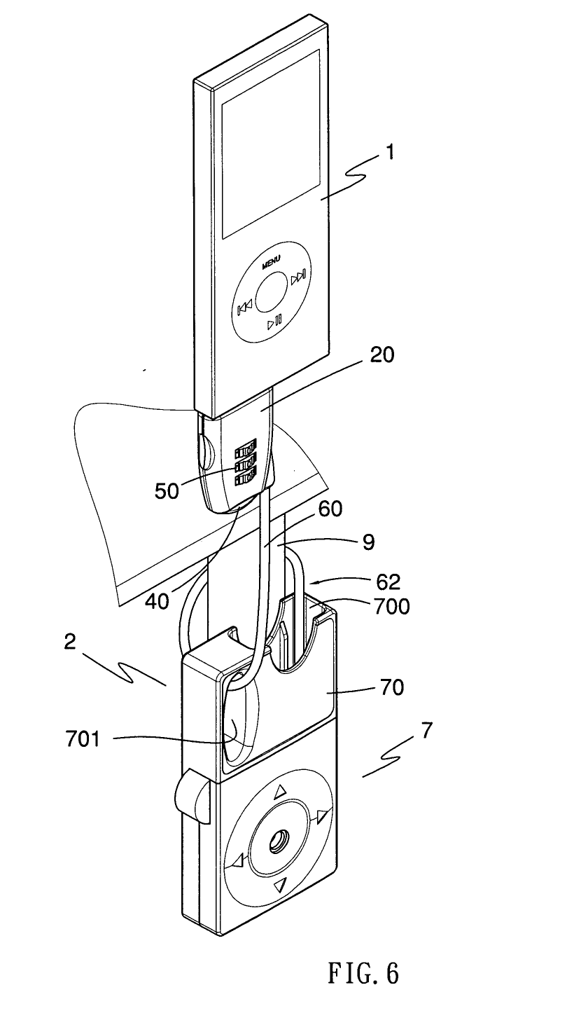

As shown in FIGS. 5 and 6, the lock further comprises a storage box 7 to connect the second end 62 of the cable 60. The storage box 7 includes a box body 70 having a receiving chamber 700 to receive the housing 20 and a through hole 701 to allow passage of the housing 20, a rotation disk 71 rotatably mounted on the box body 70 and connected to the cable 60 to wind and unwind the cable 60, and a control knob 72 mounted on the box body 70 and connected to the rotation disk 71 to control rotation of the rotation disk 71. The electronic apparatus 1 cannot pass through the through hole 701 of the box body 70 of the storage box 7. The second end 62 of the cable 60 is secured to the rotation disk 71 of the storage box 7.

As shown in FIGS. 1 and 6, the cable 60 is reeved through the fixing body 9, and the housing 20 is passed through the through hole 701 of the box body 70 of the storage box 7 so that the cable 60 and the storage box 7 are fixed on the fixing body 9. Then, the plug 31 of the snapping member 30 is directly inserted into the slot 10 of the electronic apparatus 1 to lock the electronic apparatus 1 so as to attach the electronic apparatus 1 to the fixing body 9 so that the electronic apparatus 1 is limited to move in a determined field so as to achieve an anti-theft purpose.

Accordingly, the electronic apparatus 1 is locked by the lock so as to attach the electronic apparatus 1 to the fixing body 9 by the lock so that the electronic apparatus 1 is limited to move in a determined field so as to achieve an anti-theft purpose. In addition, the plug 31 of the snapping member 30 is directly inserted into the slot 10 of the electronic apparatus 1 to lock the electronic apparatus 1, so that the lock is operated easily and conveniently, thereby facilitating the user locking the electronic apparatus 1 by the lock.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A lock, comprising:
a housing;
a snapping member mounted on the housing and including a plug protruding from the housing and inserted into a slot of an electronic apparatus, and two snapping hooks movably mounted on two opposite sides of the plug and detachably hooked onto two opposite sides of the slot of the electronic apparatus;
a control member movably mounted on the housing and movable to an open position where the two snapping hooks are detached from the slot of the electronic apparatus;
a locking mechanism mounted on the housing to limit movement of the control member to the open position.

2. The lock in accordance with claim 1, wherein each of the two snapping hooks includes a driven block elastically and swingably mounted on one of the two opposite sides of the plug, and a hook portion detachably hooked onto one of the two opposite sides of the slot of the electronic apparatus and movable relative to the plug by movement of the driven block.

3. The lock in accordance with claim 2, wherein the control member includes a press portion having an outer side protruding from the housing, and two push bars extending from the press portion toward the driven blocks of the two snapping hooks.

4. The lock in accordance with claim 3, wherein the driven block of each of the two snapping hooks has a side formed with an oblique driven face facing the respective push bar of the control member, so that when each of the push bars of the control member is rested on the driven face of the driven block of the respective snapping hook, the driven block of the respective snapping hook is movable relative to the plug.

5. The lock in accordance with claim 2, wherein the hook portion 36 of each of the two snapping hooks has a side formed with an oblique guide face.

6. The lock in accordance with claim 2, wherein the each of the two snapping hooks further includes a link having a first end connected to the driven block and a second end connected to the hook portion.

7. The lock in accordance with claim 3, wherein the locking mechanism includes a number wheel unit mounted on the housing, a control shaft extending through the number wheel unit and having an end portion rested on an inner side of the press portion of the control member, and a compression spring mounted on the control shaft and biased between the number wheel unit and the end portion of the control shaft to push the control shaft toward the press portion of the control member.

8. The lock in accordance with claim 7, wherein when the number wheel unit of the locking mechanism is disposed at an unlocked state, the control shaft is movable, and when the number wheel unit of the locking mechanism is disposed at a locked state, the control shaft is fixed.

9. The lock in accordance with claim 1, wherein the locking mechanism includes a number wheel unit mounted on the housing, a control shaft extending through the number wheel unit and having an end portion rested on the control member, and a compression spring mounted on the control shaft and biased between the number wheel unit and the end portion of the control shaft to push the control shaft toward the control member.

10. The lock in accordance with claim 9, wherein the when the number wheel unit of the locking mechanism is disposed at an unlocked state, the control shaft is movable, and when the number wheel unit of the locking mechanism is disposed at a locked state, the control shaft is fixed.

11. The lock in accordance with claim 1, wherein the plug of the snapping member has an end face formed with a receiving hole to receive a transmission connector in the slot of the electronic apparatus.

12. The lock in accordance with claim 1, further comprising a cable having a first end provided with an attachment attached to the housing and a second end reeved through a fixing body.

13. The lock in accordance with claim 12, wherein the second end of the cable is provided with a loop to allow passage of the housing, and the electronic apparatus cannot pass through the loop of the cable.

14. The lock in accordance with claim 12, further comprising a storage box to connect the second end of the cable.

15. The lock in accordance with claim 14, wherein the storage box includes:
a box body having a receiving chamber to receive the housing and a through hole to allow passage of the housing;
a rotation disk rotatably mounted on the box body and connected to the cable to wind and unwind the cable.

16. The lock in accordance with claim 15, wherein the electronic apparatus cannot pass through the through hole of the box body of the storage box.

17. The lock in accordance with claim 15, wherein the second end of the cable is secured to the rotation disk of the storage box.

18. The lock in accordance with claim 15, wherein the storage box further includes a control knob mounted on the box body and connected to the rotation disk to control rotation of the rotation disk.
